(19) United States
(12) Patent Application Publication
(10) Pub. No.: US 2026/0228528 A1
(43) Pub. Date: Aug. 6, 2026

(54) Systems and methods for lossless weight compression for back-to-back linear layers in transformers and other neural networks

(71) Applicant: Nils Graef, Dublin, CA (US)

(72) Inventor: Nils Graef, Dublin, CA (US)

(21) Appl. No.: 19/530,393

(22) Filed: Feb. 5, 2026

Related U.S. Application Data
(60) Provisional application No. 63/754,419, filed on Feb. 5, 2025.

(51) Int. Cl. G06N 3/08; G06N 3/04

(52) U.S. Cl. CPC G06N 3/08; G06N 3/04

(57) ABSTRACT

This specification discloses systems and methods for improving the inference and training efficiency of neural networks with back-to-back linear layers as present in transformer and diffusion models. Unlike standard weight compression and pruning techniques, the disclosed methods and systems use matrix inversion to reduce the total number of weights in an exact, mathematically equivalent way and thus without compromising model accuracy. The elimination of weights results in lower compute and memory complexities, and thus lower cost-per-token for generative AI. One embodiment of the invention reduces the total number of weights of a standard transformer model. Another embodiment of the invention discloses a simplified multi-head attention (MLA) scheme with lower memory and compute complexities.

### CROSS-REFERENCE TO RELATED APPLICATIONS

This application claims priority to the U.S. Provisional Application No. 63/754,419, filed on Feb. 5, 2025. The entire content of the foregoing provisional application is hereby incorporated by reference.

### PRIOR ART

Chi-Heng Lin, Shangqian Gao, et al., “MoDeGPT: Modular Decomposition for Large Language Model Compression,” 2024, arXiv:2408.09632.
Pratyusha Sharma, Jordan T Ash, et al., “The truth is in there: Improving reasoning in language models with LAyer-SElective Rank reduction,” 2023, arXiv:2312.13558.
Alec Radford, Jong Wook Kim, et al., “Robust speech recognition via large-scale weak supervision,” 2022, arXiv:2212.04356.
CodeGemma Team, Heri Zhao, et al., “CodeGemma: Open Code Models Based on Gemma,” 2024, arXiv:2406.11409.
Colin Raffel, Noam Shazeer, et al., “Exploring the limits of transfer learning with a unified text-to-text transformer,” 2019, arXiv:1910.10683.
DeepSeek-AI, Aixin Liu, et al., “DeepSeek-V2: A Strong, Economical, and Efficient Mixture-of-Experts Language Model,” 2024, arXiv:2405.04434.
Yuan Yao, Tianyu Yu, et al., “MiniCPM-V: A GPT-4V Level MLLM on Your Phone,” 2024, arXiv:2408.01800.

### BACKGROUND OF THE INVENTION

This specification relates to artificial intelligence (AI) and machine learning, and more particularly to systems and methods for optimizing the inference and training process of neural networks with back-to-back linear layers, such as transformer models and diffusion models.

Transformer neural networks form the foundation of various generative artificial intelligence models, including large language models (LLMs), large multimodal models (LMMs), small language models (SLMs), vision language models (VLMs), and diffusion models. Attention layers are at the heart of transformer models. The memory and compute complexities associated with inference and training of transformer models remain significant, particularly as model sizes and context window lengths increase.

### SUMMARY OF THE INVENTION

This specification describes systems and methods for improving the inference and training efficiency of neural networks with back-to-back linear layers such as the back-to-back linear layers inside the attention layers of transformer models. The disclosed methods and systems reduce the total number of weights resulting in lower compute and memory complexities.

The disclosed methods and systems provide an exact, mathematically identical implementation of the original back-to-back linear layers and therefore do not compromise model accuracy. In other words, the disclosed methods and systems losslessly compress the back-to-back linear layers present in transformer and diffusion models.

In the remainder of this specification, the disclosed systems and methods are referred to as MatShrink. Furthermore, we use the shorthand Q, K, V, and KV for Queries, Keys, Values, and Key-Value pairs, respectively.

### BRIEF DESCRIPTION OF DRAWINGS

FIG. 1 depicts mathematically equivalent implementations of two back-to-back weight matrices W_{A} and W_{B} with rank r, where d>r and e>r, which reduces the total number of weights by r².

FIG. 2 illustrates an alternative way of shrinking W_{A} instead of W_{B}.

FIG. 3 illustrates MatShrink for V and O projections of a single attention head: (a) original V and O projections; (b) equivalent implementation using MatShrink, which eliminates r² weights from W_{O}.

FIG. 4 shows an alternative MatShrink implementation for V and O projections of a single attention head: (a) original V and O projections; (b) equivalent implementation using the alternative MatShrink scheme from FIG. 2, which eliminates r² weights from W_{V}.

FIG. 5 depicts MatShrink for Q and K projections of a single attention head. Left: original Q and K projections and their dot-product p. Right: equivalent implementation using MatShrink, which eliminates r² weights from W_{Q}.

FIG. 6 illustrates an alternative MatShrink implementation for Q and K projections of a single attention head. Left: original Q and K projections and their dot-product p. Right: equivalent implementation using MatShrink, which eliminates r² weights from W_{K} (instead of W_{Q}).

FIG. 7 shows K and V projections for MLA. (a) original version; (b) equivalent version optimized by MatShrink; (c) disclosed simplification.

FIG. 8 lists the weight savings for MHA transformer models using MatShrink.

FIG. 9 lists configurations of various MLA models.

### DETAILED DESCRIPTION OF THE INVENTION

MatShrink reduces the number of weights for back-to-back matrices in general, and for transformer models in particular. MatShrink uses matrix inversion to eliminate weights in a mathematically equivalent way and thus without compromising model accuracy. MatShrink is applicable to both inference and training: Existing models can be retrofitted with MatShrink in a mathematically equivalent way, and future models can use MatShrink for both training and inference. MatShrink also provides a simplified MLA (multi-head latent attention) scheme.

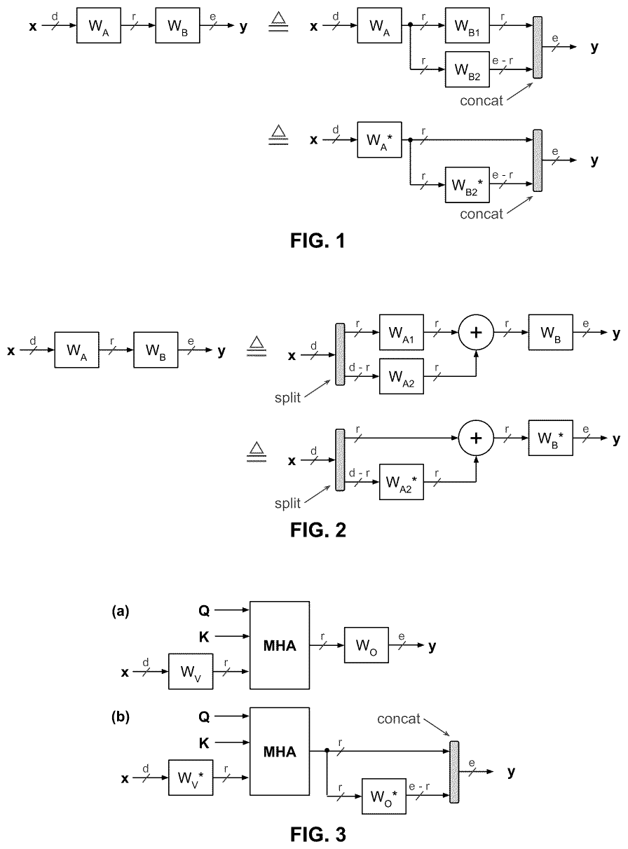

For two back-to-back weight matrices W_{A} and W_{B}, FIG. 1 illustrates how MatShrink reduces the size of W_{B} in a mathematically equivalent way by using matrix inversion.

Specifically, W_{A} is a d×r matrix, W_{B} is an r×e matrix with rank r, where d>r and e>r. We can split W_{B} into two submatrices W_{B1} (which is an r×r matrix) and W_{B2} such that W_{B}=[W_{B1},W_{B2}]. We can then eliminate W_{B1} by merging it into W_{A} as

$${W}_{A}^{*} = {W}_{A} {W}_{B 1}$$

and by changing

$${W}_{B 2} to {W}_{B 2}^{*} = {W}_{B 1}^{- 1} {W}_{B 2} .$$

This saves r² weights and r² multiply operations per token x. The following equation shows the mathematical identity of the modified back-to-back matrices, where I is the r×r identity matrix: W=W_{A}·W_{B}=W_{A}·[W_{B1},W_{B2}] and thus

$$W = {W}_{A} {W}_{B 1} \cdot [ I , {W}_{B 1}^{- 1} {W}_{B 2} ] = {W}_{A}^{*} \cdot [ I , {W}_{B 2}^{*} ] .$$

Inverting the submatrix W_{B1} requires that this submatrix is invertible, which is often the case because it is extremely rare for large matrices to be non-invertible. In the rare case that W_{B1} is non-invertible, we can first permute the columns of the original matrix W_{B} such that the first r columns of the permuted matrix form an invertible submatrix W_{B1}.

For completeness, if e=r, then the entire matrix W_{B2} is eliminated. In general, if e≤r, then the two matrices W_{A} and W_{B} are fused into a single matrix W*=W_{A}·W_{B} with only d·e weights (instead of dr+re weights for the original matrices W_{A} and W_{B}).

Alternatively, we can split matrix W_{A} into two submatrices W_{A1} and W_{A2} such that W_{A}=[W_{A1}; W_{A2}]. We can then eliminate W_{A1} as

$$W = [ {W}_{A 1} ; {W}_{A 2} ] {W}_{B} = [ I ; {W}_{A 2}^{*} ] {W}_{B}^{*}$$

with the r×r identity matrix I and where

$${W}_{B}^{*} = {W}_{A 1} {W}_{B} and {W}_{A 2}^{*} = {W}_{A 2} {W}_{A 1}^{- 1} ,$$

see FIG. 2. This also saves r² weights and r² multiply operations per each token x.

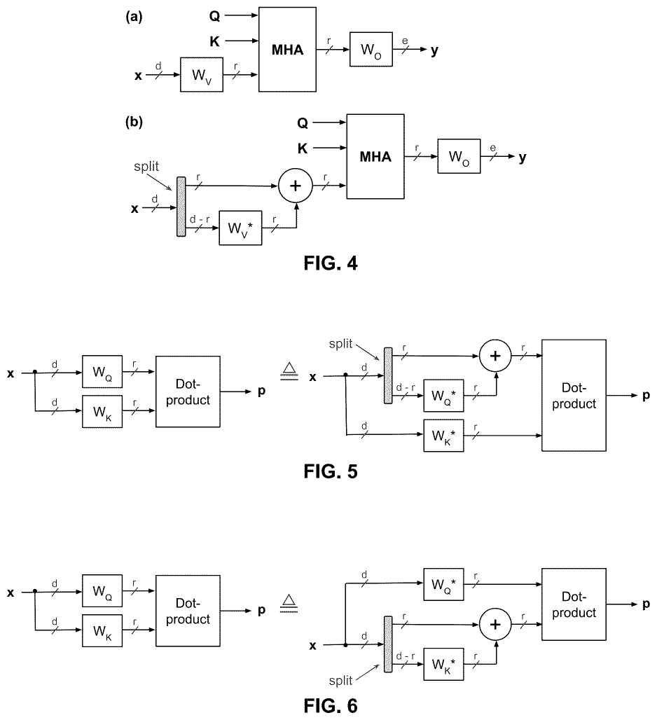

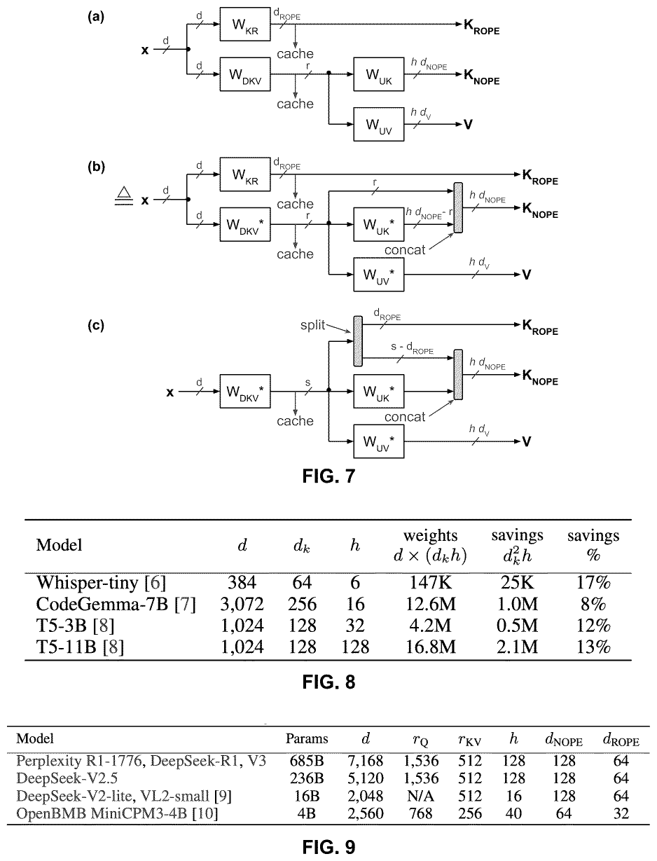

MatShrink reduces the number of weights for the following three back-to-back weight matrices in transformer models: (1) The V (value) and O (output) projections for each attention-head, see FIG. 3 and FIG. 4. (2) The Q (query) and K (key) projections for each attention-head (without the ROPE portion), see FIG. 5 and FIG. 6. And (3), the latent projections of MLA (multi-head latent attention), see FIG. 7(b).

Many weight compression schemes for transformers have been proposed such as MoDeGPT (Modular Decomposition for Large Language Model Compression) and LASER (Layer-Selective Rank Reduction). However, these schemes approximate the original weight matrices by using SVD (singular value decomposition) or other approximations. MatShrink on the other hand is not an approximation but an exact, mathematically equivalent optimization for back-to-back matrices.

MatShrink for V and O projections is detailed in this section. Note that the value (V) and output (O) projections for each head i of multi-head attention (MHA) form two back-to-back weight matrices W_{V,i} and W_{O,i} as illustrated in FIG. 3 for a single attention head. FIG. 3 shows how MatShrink eliminates r² weights from the original O projection weight matrix W_{O}. Alternatively, FIG. 4 illustrates how the alternative MatShrink scheme from FIG. 2 can eliminate r² weights from the original V projection (instead of the O projection).

For MHA, we can apply the MatShrink scheme to each head. Specifically: For the standard MHA with h heads, each head has dimension dₖ=d/h, and d=d_{model}. So for the dimensions r and e of FIG. 1, we have r=d/h and e=d. This saves r²=d²/h² weights for each head, so d²/h weights in total. Note that for single-head attention (where h=1), we can save 2 d² weights (i.e. we can merge the V and O weight matrices into a single d×d matrix; and the Q and K weight matrices into a single d×d matrix (if there is no RoPE).

FIG. 8 lists the configurations of various MHA transformer models, the number of weights for their attention projections, and the weight savings provided by MatShrink.

MatShrink for Q and K projections is described next. For models that don't use ROPE (such as Whisper and T5 models), the query (Q) and key (K) projections for each head i of MHA form two back-to-back weight matrices W_{Q,i} and W_{K,i} as illustrated in FIG. 5 for a single attention head.

FIG. 5 shows how MatShrink eliminates r² weights from the original Q weight matrix W_{Q}. Note that the queries Q* and keys K* generated by the modified linear layers

$${W}_{Q}^{*} and {W}_{K}^{*}$$

are not identical to the original queries Q and keys K, but their dot-products p are identical, i.e. p=Q·K=Q*·K*.

For many models that use RoPE, we can also apply this trick as follows: Many modern transformer models use partial ROPE, which applies ROPE to only a portion of the head-dimension dₖ=d/h, usually only to one half of dₖ. Therefore in this case r=dₖ/2=d/(2h), which saves only r²=d²/(4h²) weights for each head, so d²/(4h) weights in total.

For completeness, FIG. 6 illustrates an alternative implementation of MatShrink that removes r² weights from W_{K} instead of W_{Q}.

MatShrink for MLA transformers is detailed next. FIG. 9 shows the configurations of various transformer models with MLA. We are using the following parameter names similar to DeepSeek's V2 paper. For queries (Q), r_{Q} is the rank of the Q-latent projection, W_{DQ} is the down-projection for Q, W_{UQ} is the up-projection for the Q-part without ROPE (also known as NoPE), and W_{QR} is the up-projection for the Q-part with RoPE. And for key-values (KV), r_{KV} is the rank of the KV-latent projection, W_{KR} is the projection for the K-part with RoPE (it has its own cache and is used for all queries as MQA), W_{DKV} is the down-projection for KV, W_{UK} is the up-projection for the K-part without RoPE (also known as NoPE), and W_{UV} is the up-projection for V.

DeepSeek's MLA (multi-head latent attention) scheme has two latent projections, one for Q (queries) and one for KV (keys and values). We can apply MatShrink to each of them: (1) The Q-latent projection and query (Q) projections are two back-to-back weight matrices W_{DQ} and W_{UQ}. (2) The KV-latent projection and key/value (KV) projections are two back-to-back weight matrices W_{DKV} and the union of W_{UK} and W_{UV}.

We can also apply MatShrink to each V-O head and the non-ROPE portion of the Q-K heads. Specifically, we can apply the MatShrink to the MLA weight matrices in the following order: First, apply MatShrink to the V-O weight matrices. Second, apply MatShrink to the NoPE portion (i.e. the non-RoPE portion) of the Q-K weight matrices. Third, apply MatShrink to the Q-latent projections. This step must be done after applying MatShrink to the Q-K weights. Fourth, apply MatShrink to the KV-latent projections. This step must be done after applying MatShrink to the V-O weights.

Applying MatShrink to the KV-latent projections not only reduces weight matrices and corresponding compute, it can also reduce the compute complexity as follows, where r_{KV} is the rank of the KV-latent projections. Option 1: Use the r_{KV} neurons that don't require a weight matrix as keys. The number of those keys is r_{KV}/d_{NOPE}. Then these keys can be directly used for the softmax arguments, which saves some computation complexity. Option 2: Use the r_{KV} neurons as values (instead of keys). Then these values can be directly multiplied with the softmax scores, which saves some compute complexity.

In the next sections we disclose a simplification for DeepSeek's MLA (multi-head latent attention). FIG. 7 shows the K and V projections of MLA and the disclosed simplification. FIG. 7(a), FIG. 7(b), and FIG. 7(c) are detailed as follows: FIG. 7(a) shows the MLA projections for K (keys) and V (values). Note that a single d_{ROPE} head is shared among all query-heads, where d_{ROPE}=64 or 32 usually. FIG. 7(b) shows the mathematically equivalent version with MatShrink applied to the weight matrices W_{DKV} and W_{UK}.

FIG. 7(c) shows the disclosed simplified MLA scheme where the d_{ROPE} units (or channels) are sourced directly from the latent cache, instead of having a separate cache and W_{KR} for the d_{ROPE} units. Note that this simplified scheme is not mathematically identical to the standard MLA scheme shown in FIG. 7(a). The rank s of the simplified scheme could be larger than r (e.g. s=r+d_{ROPE}) or slightly lower than this (e.g. s=r).

The advantages of the disclosed simplified MLA scheme are as follows: If s>r, then there is more usable rank for the keys and values. Thus, the cached latent space is better utilized. And if s<r+d_{ROPE} then the total cache size is reduced.

The disclosed simplification enhances MLA by directly leveraging the latent cache for RoPE components, potentially increasing effective rank and optimizing cache utilization. In DeepSeek-V2, standard MLA already reduces KV cache by compressing into latent vectors, but our proposal further streamlines this by eliminating separate ROPE projections, leading to additional memory savings especially for long-sequence inference.

MatShrink is not limited to MHA and MLA only. It's also applicable to GQA (grouped query attention) and MQA (multi-query attention). However, the savings are smaller than for MHA and MLA. Specifically, the savings are reduced by a factor g, where g is the number of queries that are shared among a single KV-pair, or in other words g=n_{heads}/n_{KV-heads} (where n_{heads} is the number of query-heads, and n_{KV-heads} is the number of KV-heads).

Approximate weight compression schemes such as LASER and MoDeGPT use SVD (singular value decomposition) to reduce the ranks of weight matrices, and thus reduce the number of weights. This is applicable for example for the large weight matrices of the transformer's FFN (feedforward networks). The SVD decomposition factorizes the original d×e matrix W into two matrices W_{A} and W_{B} where r is the compressed rank. After performing SVD and compressing the rank by a certain percentage, we can then eliminate r² weights using our MatShrink scheme. Note that reducing the rank by a certain percentage is not an exact implementation of the original matrix W but an approximation.

The disclosed inventions are not limited to inference or transformer neural networks only. The neural network architectures depicted in figures FIG. 3 to FIG. 7 can already be used for training to eliminate the offline computing of the modified weight matrices before inference time and to increase numerical accuracy. Furthermore, the disclosed inventions can be applied to other neural networks that use attention layers (such as diffusion models) as well as any neural network with back-to-back linear layers.

1. A computer-implemented method for optimizing a neural network, the method comprising: identifying a sequence of back-to-back linear layers within a neural network architecture; generating a reduced set of weights for said sequence of back-to-back linear layers using matrix inversion, wherein the reduced set of weights contains fewer total weights than the original sequence; and configuring the neural network to execute an inference or training operation using the reduced set of weights; wherein the execution using the reduced set of weights is mathematically equivalent to the execution using the original sequence of back-to-back linear layers.

2. The method of claim 1, wherein the neural network is a transformer model or a diffusion model.

3. The method of claim 1, wherein there are two back-to-back linear layers with weight matrices W_{A} and W_{B} for the first (W_{A}) and second (W_{B}) linear layers as illustrated in FIG. 1, wherein the method of reducing the size of the weight matrix W_{B} comprises: splitting weight matrix W_{B} into two submatrices W_{B1} and W_{B2} where W_{B1} is a square matrix such that W_{B}=[W_{B1},W_{B2}]; eliminating submatrix W_{B1} by fusing it with matrix W_{A} as
$${W}_{A}^{*} = {W}_{A} {W}_{B 1}$$
and by changing W_{B2} to
$${W}_{B 2}^{*} = {W}_{B 1}^{- 1} {W}_{B 2} ,$$
wherein
$${W}_{B 1}^{- 1}$$
is the matrix inverse of submatrix W_{B1}; wherein this transformation is mathematically equivalent to the original sequence of back-to-back linear layers and eliminates r² weights and multiplications where r is the dimension of the r×r square submatrix W_{B1}.

4. The method of claim 1, wherein there are two back-to-back linear layers with weight matrices W_{A} and W_{B} for the first (W_{A}) and second (W_{B}) linear layers as illustrated in FIG. 2, wherein the method of reducing the size of the weight matrix W_{A} comprises: splitting weight matrix W_{A} into two submatrices W_{A1} and W_{A2} where W_{A1} is a square matrix such that W_{A}=[W_{A1}; W_{A2}]; eliminating submatrix W_{A1} by fusing it with matrix W_{B} as
$${W}_{B}^{*} = {W}_{A 1} {W}_{B}$$
and by changing W_{A2} to
$${W}_{A 2}^{*} = {W}_{A 2} {W}_{A 1}^{- 1} ,$$
wherein
$${W}_{A 1}^{- 1}$$
is the matrix inverse of submatrix W_{A1}; wherein this transformation is mathematically equivalent to the original sequence of back-to-back linear layers and eliminates r² weights and multiplications where r is the dimension of the r×r square submatrix W_{A1}.

5. The method of claim 3, wherein the two back-to-back linear layers are the value (V) and output (O) projections for each head of multi-head attention (MHA), multi-latent attention (MLA), multi-query attention (MQA), or grouped-query attention (GQA) of an attention layer in a neural network as illustrated in FIG. 3.

6. The method of claim 4, wherein the two back-to-back linear layers are the value (V) and output (O) projections for each head of multi-head attention (MHA), multi-latent attention (MLA), multi-query attention (MQA), or grouped-query attention (GQA) of an attention layer in a neural network as illustrated in FIG. 4.

7. The method of claim 4, wherein the two back-to-back linear layers are the query (Q) and key (K) projections or vice versa for each head of multi-head attention (MHA), multi-latent attention (MLA), multi-query attention (MQA), or grouped-query attention (GQA) of an attention layer in a neural network as illustrated in FIG. 5 and FIG. 6 such that the dot-products of the query and key projections are mathematically equivalent to the dot-products generated by the original query and key projections.

8. The method of claim 3, wherein the two back-to-back linear layers are the query-latent and query (Q) projections of multi-latent attention (MLA) of an attention layer in a neural network.

9. The method of claim 4, wherein the two back-to-back linear layers are the query-latent and query (Q) projections of multi-latent attention (MLA) of an attention layer in a neural network.

10. The method of claim 3, wherein the two back-to-back linear layers are the KV-latent (key-value latent) projection and KV (key-value) projection of multi-latent attention (MLA) of an attention layer in a neural network as illustrated in FIG. 7(b).

11. The method of claim 10, wherein the separate cache and weight matrix solely used for the ROPE (Rotary Positional Embedding) units is eliminated and instead the ROPE units are directly sourced from the latent cache to better utilize the latent cache as illustrated in FIG. 7(c).

12. The method of claim 4, wherein the two back-to-back linear layers are the KV-latent (key-value latent) projection and KV (key-value) projection of multi-latent attention (MLA) of an attention layer in a neural network.

13. The method of claim 3, wherein the two original back-to-back linear layers have been obtained by factorizing an originally larger weight matrix into two smaller matrices by using approximate weight compression schemes such as SVD (singular value decomposition); wherein this originally larger weight matrix is a linear layer of a neural network such as the linear layers of the feedforward network (FFN) in an LLM (large language model) as conceptually illustrated in FIG. 1.

14. The method of claim 4, wherein the two original back-to-back linear layers have been obtained by factorizing an originally larger weight matrix into two smaller matrices by using approximate weight compression schemes such as SVD (singular value decomposition); wherein this originally larger weight matrix is a linear layer of a neural network such as the linear layers of the feedforward network (FFN) in an LLM (large language model) as conceptually illustrated in FIG. 2.
